(19) United States
(12) Patent Application Publication
(10) Pub. No.: US 2022/0014648 A1
(43) Pub. Date: Jan. 13, 2022

(54) DISPLAY CONTROL APPARATUS, IMAGE CAPTURING AND PROCESSING APPARATUS, IMAGE CAPTURING APPARATUS, AND METHOD OF CONTROLLING IMAGE CAPTURING AND PROCESSING APPARATUS

(71) Applicant: CANON KABUSHIKI KAISHA, Tokyo (JP)

(72) Inventor: Shogo Matsumoto, Kanagawa (JP)

(21) Appl. No.: 17/368,631

(22) Filed: Jul. 6, 2021

(30) Foreign Application Priority Data
Jul. 9, 2020 (JP) 2020-118531

(51) Int. Cl. H04N 5/04; H04N 5/60; H04N 21/44

(52) U.S. Cl. CPC H04N 5/04; H04N 21/44; H04N 5/60

(57) ABSTRACT

A display control apparatus is provided which performs operations as a delay time information acquisition unit configured to acquire information on a delay time from when a display image to be displayed on a display unit is acquired from an image capturing signal output from an image capturing device to when the display image is displayed on the display unit. The display control apparatus also performs operations as a display control unit configured to control display of the display image on the display unit at a timing based on the acquired information on the delay time, wherein the delay time is longer when a distance to a sound source is a second value than when the distance to the sound source is a first value, the second value being greater than the first value.

### BACKGROUND

### Field

The present disclosure relates to a display control apparatus, an image capturing and processing apparatus, an image capturing apparatus, and a method of controlling the image capturing and processing apparatus.

### Description of the Related Art

When a moving image of an object is captured by an image capturing and processing apparatus having a function of recording a movie, such as a video camera, in a case where the object outputs audio and a distance between the object and the image capturing and processing apparatus is large, a lag between the audio and the captured moving image occurs due to difference between the speed of sound and the speed of light. In cases other than moving image capturing such as in live-view display during still image capturing or in view display by the image capturing and processing apparatus specializing in a display function such as digital binoculars, the lag between the view-displayed object image and the audio arriving at ears of an operator can give the operator a feeling of strangeness.

Japanese Patent Application Laid-Open No. 2017-11619 discusses a technique that detects a motion vector of each of frames constituting a moving image, detects a peak timing of a sound signal, and adjusts relative timings of an image signal and the sound signal based on respective detection results.

Further, Japanese Patent Application Laid-Open No. 2002-290767 discusses a technique that detects a time lag between an audio signal and an image signal with respect to a loss of synchronization between the audio and the image generated due to processing time difference between audio signal processing and image signal processing, and corrects a synchronization time based on the detected time lag when the audio signal and the image signal are processed as signals to be transmitted to outside.

### SUMMARY

According to various embodiments of the present disclosure, a display control apparatus includes at least one processor, and a memory coupled to the at least one processor. The memory has instructions that, when executed by the at least one processor, cause the display control apparatus to perform operations as a delay time information acquisition unit configured to acquire information on a delay time from when a display image to be displayed on a display unit is acquired from an image capturing signal output from an image capturing device to when the display image is displayed on the display unit, and a display control unit configured to control display of the display image on the display unit at a timing based on the information on the delay time, wherein the delay time is longer when a distance to a sound source is a second value than when the distance to the sound source is a first value, the second value being greater than the first value.

Further features of the present disclosure will become apparent from the following description of exemplary embodiments with reference to the attached drawings.

### BRIEF DESCRIPTION OF THE DRAWINGS

FIG. 1 is a diagram schematically illustrating a configuration of a digital monocle as an example of an image capturing and processing apparatus according to an exemplary embodiment of the present disclosure.

FIG. 2 is a block diagram illustrating a hardware configuration of the digital monocle illustrated in FIG. 1.

FIG. 3 is a flowchart illustrating display delay processing according to a first exemplary embodiment.

FIG. 4 is a flowchart illustrating delay time acquisition processing according to the first exemplary embodiment.

FIG. 5 is a flowchart illustrating delay time acquisition processing according to a third exemplary embodiment.

FIG. 6 is a flowchart illustrating display delay processing according to a fourth exemplary embodiment.

### DESCRIPTION OF THE EMBODIMENTS

Various exemplary embodiments of the present disclosure are described in detail below with reference to the accompanying drawings. In the drawings, the same members are denoted by the same reference numerals, and repetitive descriptions are omitted.

In both of the techniques discussed in Japanese Patent Application Laid-Open Nos. 2017-11619 and 2002-290767, a difference between a time for light to arrive at the image capturing apparatus and a time for audio to arrive at the image capturing apparatus is not considered. Thus, a time lag may occur between a time the audio is directly heard by the operator or the audio signal is input to and recorded in an audio input unit of the image capturing apparatus, and a time that the image signal is acquired by the image capturing apparatus. In the following exemplary embodiments, an image capturing and processing apparatus that can reduce the time lag is described.

In a first exemplary embodiment, a digital monocle is described that is an example of an image capturing and processing apparatus according to various embodiments of the present disclosure. In the described digital monocle, a time lag between a displayed image signal and audio directly heard by ears of an operator (user) is reduced.

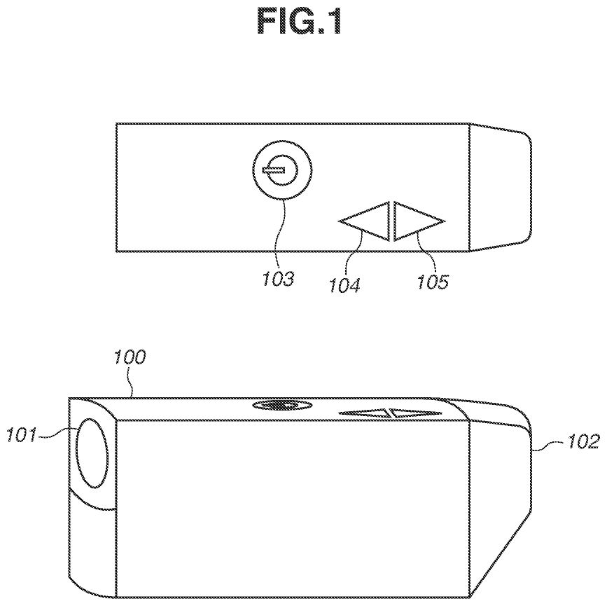

FIG. 1 is a diagram schematically illustrating a configuration of a digital monocle 100. In the present exemplary embodiment, as noted above, a digital monocle is described; however, in other embodiments, a digital camera, digital binoculars, a smartphone, and the like may be implemented as the image capturing and processing apparatus. The digital monocle 100 includes an image capturing lens unit 101, a display unit 102, and various kinds of operation units.

The image capturing lens unit 101 is an image capturing optical system that includes an image capturing lens consisting of a zoom lens and a focus lens protected by a barrier member, and an actuator for driving the lenses. The image capturing lens unit 101 optically controls an image capturing field angle in response to a user operation. The display unit 102 is an electronic viewfinder, includes a display device such as a liquid crystal display or an organic electroluminescent (EL) display, and displays a live-view image in an image capturing direction. A power supply switch 103 is an operation unit to turn on and off the digital monocle 100. A telephoto-side zoom button 104 and a wide-side zoom button 105 are operation units to receive a user instruction about a zoom magnification. The telephoto-side zoom button 104 is the operation unit to instruct zoom control toward a telephoto side, and the wide-side zoom button 105 is the operation unit to instruct zoom control toward a wide side (wide-angle side). The operation buttons and a system control unit 210 described below function as a zoom magnification setting unit configured to set the zoom magnification to the digital monocle 100.

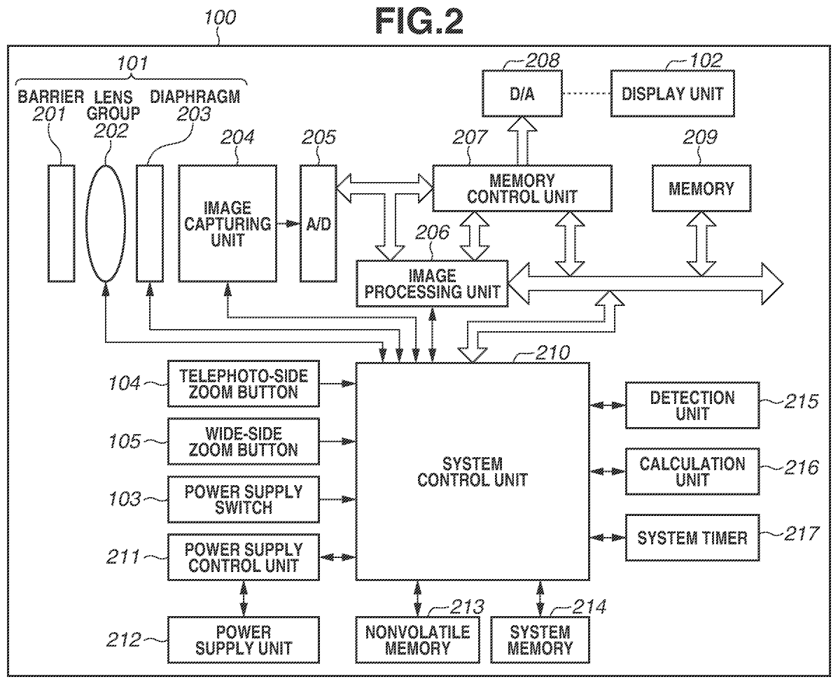

FIG. 2 is a block diagram illustrating a hardware configuration of the digital monocle 100. Components are described. The display unit 102, the power supply switch 103, the telephoto-side zoom button 104, and the wide-side zoom button 105 have been described with reference to FIG. 1. Thus, descriptions of these components are omitted. The digital monocle 100 includes a barrier 201, a lens group 202, a diaphragm 203, and an image capturing unit 204. The barrier 201, the lens group 202, and the diaphragm 203 are components of the image capturing lens unit 101. The barrier 201 covers the lens group 202 to prevent the image capturing optical system from dust and damage. The lens group 202 includes a plurality of lenses including the zoom lens and the focus lens. An optical configuration of the lens group 202 is adjusted to correspond to the zoom magnification instructed and set via the system control unit 210, based on operation of the telephoto-side zoom button 104 and the wide-side zoom button 105. The diaphragm 203 adjusts an exposure amount of the image capturing unit 204 under the control of the system control unit 210.

The image capturing unit 204 is an image capturing device that converts an optical image formed by the image capturing optical system into an image capturing signal (analog signal) that is an electric signal. An example of the image capturing device is an image sensor such as a charge-coupled device (CCD) sensor or a complementary metal-oxide semiconductor (CMOS) sensor having a Bayer array structure in which RGB pixels are regularly arranged.

The digital monocle 100 further includes an analog-to-digital (A/D) converter 205, an image processing unit 206, a memory control unit 207, a digital-to-analog (D/A) converter 208, a memory 209, and the system control unit 210. The image capturing signal output from the image capturing unit 204 is input to the A/D converter 205. The A/D converter 205 converts the acquired analogue image capturing signal into image data including a digital image capturing signal, and outputs the image data to the image processing unit 206 or the memory control unit 207.

The image processing unit 206 performs various image processing. The image processing unit 206 performs correction processing such as pixel interpolation and shading correction, white balance processing, gamma correction processing, color conversion processing, and other processing on the image data acquired from the A/D converter 205 or data acquired from the memory control unit 207. Further, the image processing unit 206 performs image extraction processing and variable magnification processing to implement an electronic zoom function. Furthermore, the image processing unit 206 performs predetermined calculation processing by using image data of a captured image, and outputs an obtained calculation result to the system control unit 210. The system control unit 210 performs exposure control and ranging control based on the calculation result of the image processing unit 206. The system control unit 210 performs, for example, through-the-lens (TTL) autofocus (AF) processing and autoexposure (AE) processing based on the calculation result of the image processing unit 206. Further, the image processing unit 206 performs predetermined calculation processing by using the image data of the captured image, and the system control unit 210 performs TTL automatic white balance (AWB) processing by using an obtained calculation result. In addition, in a case where the image data acquired from the A/D converter 205 is image data in a format that allows parallax information to be obtainable, the image processing unit 206 calculates the parallax information to calculate a distance to an object.

The image data output from the A/D converter 205 is written to the memory 209 via the image processing unit 206 or the memory control unit 207. The memory 209 is an image display memory (video memory) storing image data to be displayed on the display unit 102, and has a storage capacity enough to store a live-view image of a predetermined length of time. The memory 209 can also be used as a work area for the system control unit 210 to load programs or the like read from a nonvolatile memory 213 and a system memory 214 described below.

The image data stored in the memory 209 is transmitted to the D/A converter 208 via the memory control unit 207. The D/A converter 208 converts the received image data into an analog signal, and supplies the analog signal to the display unit 102. Then, the display unit 102 displays an image based on the analog signal from the D/A converter 208. The D/A converter 208 converts the digital signal that is provided from the image capturing unit 204 and is accumulated in the memory 209 via the A/D converter 205, into the analog signal, and the analog signal is successively displayed on the display unit 102, which makes it possible to implement a live-view function displaying the live-view image. A timing at which the image is displayed on the display unit 102 is controlled by the system control unit 210 based on time information about a live-view image display timing calculated by a calculation unit 216 described below. The control of the timing at which the image is displayed is described in detail below.

The digital monocle 100 further includes the nonvolatile memory 213, the system memory 214, a detection unit 215, the calculation unit 216, and a system timer 217. The nonvolatile memory 213 is an electrically erasable/writable memory (e.g., electrically erasable programmable read only memory (EEPROM)), and stores programs and operation constants for the system control unit 210. Further, the nonvolatile memory 213 has an area storing system information and an area storing user setting information. The system control unit 210 reads and restores various types of information and settings stored in the nonvolatile memory 213 at startup of the digital monocle 100.

The system control unit 210 includes a central processing unit (CPU), and performs various kinds of programs stored in the nonvolatile memory 213, thereby controlling the entire operation of the digital monocle 100. The programs, the operation constants, and operation variables read from the nonvolatile memory 213 by the system control unit 210 are loaded into the system memory 214. A random access memory (RAM) is used for the system memory 214. Further, the system control unit 210 performs display control by controlling the memory 209, the D/A converter 208, and the display unit 102. More specifically, the system control unit 210 controls readout of the image data by the memory control unit 207 based on the time information calculated by the calculation unit 216, and controls a timing at which the image data is transferred to the D/A converter 208, thereby displaying the image on the display unit 102.

The detection unit 215 includes a gyroscope, a distance sensor, and a position sensor, and acquires angular velocity information, positional information, distance information, and other information on the digital monocle 100. The angular velocity information includes information on an angular velocity and an angular acceleration in panning of the digital monocle 100. The positional information includes relative positional information on the digital monocle 100 to a specific reference position. The distance information includes information on a distance between a sound source and the digital monocle 100, such as distance information to the object that is the sound source. Such distance information is obtained, for example, by the sensor emitting light to the object and receiving the reflected light.

The calculation unit 216 performs various calculation processing by using, as inputs, the information obtained from the detection unit 215, the data stored in the memory 209, the nonvolatile memory 213, and the system memory 214, and the processing result of the image processing unit 206. The time information about the timing at which the image is displayed on the display unit 102 is also calculated by the calculation unit 216. The system timer 217 measures a time used for various kinds of control and a time of a built-in clock.

The digital monocle 100 includes a power supply control unit 211 and a power supply unit 212. The power supply unit 212 is a primary battery such as an alkaline battery and a lithium (Li) battery, or a secondary battery such as a nickel-cadmium (NiCd) battery, a nickel-metal hydride (NiMH) battery, and a lithium-ion battery, and supplies power to the power supply control unit 211. The power supply control unit 211 detects presence/absence of an attached battery in the power supply unit 212, a type of the attached battery, and a remaining level of the attached battery, and supplies a necessary voltage to each of the units for a necessary period, based on a detection result and an instruction from the system control unit 210.

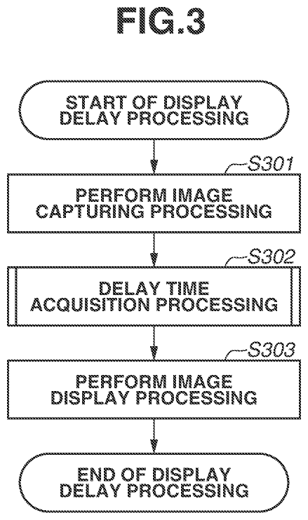

As described above, in the present exemplary embodiment, display processing that delays and adjusts the display timing of the live-view image on the display unit 102 based on the distance to the object is performed. The processing according to the present exemplary embodiment is described below with reference to a flowchart of display delay processing illustrated in FIG. 3.

In step S301, which is an image capturing processing step, the power supply switch 103 is turned on, and an image is captured for live-view display of the display unit 102. More specifically, light having passed through the image capturing lens unit 101 and the diaphragm 203 forms an image on the sensor of the image capturing unit 204, and exposure is performed for a predetermined time. Analog data of the light to which the sensor is exposed is converted into digital data by the A/D converter 205. Image data for display in a format for displaying the image on the display unit 102 is generated from the converted digital data via the image processing unit 206 and the memory control unit 207. At this time, as setting values serving as a base of the image data generation, the data stored in the nonvolatile memory 213 and the system memory 214 and the data obtained by calculating the data by the calculation unit 216 are used via the system control unit 210. The generated image data for display is once stored in the memory 209.

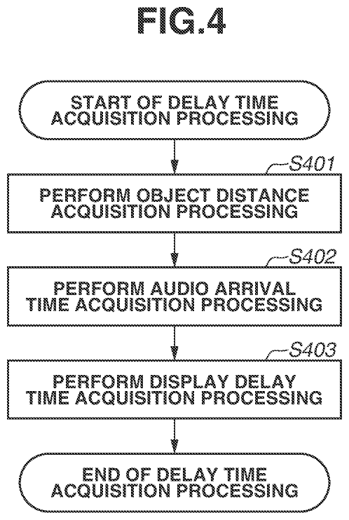

In step S302, which is a delay time acquisition processing step, the calculation unit 216 acquires information on a delay time for delaying the timing at which an image of the image data for display generated in step S301 is displayed on the display unit 102, from a time point when the image data is generated. A specific acquisition procedure according to the present exemplary embodiment is described with reference to a flowchart of delay time acquisition processing illustrated in FIG. 4.

In step S401, which is an object distance acquisition processing step, the distance information to the object is acquired. The distance information is acquired from, for example, a detection result of the distance sensor included in the detection unit 215. In a case where the image data undergoing the processing in step S301 is the image data including parallax information, the distance information to the object may be acquired from calculation based on the parallax information. In addition, such as a case where the image capturing and processing apparatus is provided to each of seats in various kinds of event sites for sporting events and concerts, there is a case where the image capturing and processing apparatus is expected to be used at a designated position, and the relative position at which the image capturing and processing apparatus is used to the position of the object (position on the field or stage) is determined. In such a case, the object distance information may be input in advance to the image capturing and processing apparatus and stored in any of the memory 209, the nonvolatile memory 213, and the system memory 214, and the object distance may be acquired by reading the stored object distance information in this step. Alternatively, an organizer of an event may store a table of a seat number and the distance to the object in the memory of the image capturing and processing apparatus, and the user may input the user's own seat number to acquire a distance between the seat and the object. Further, alternatively, the table of the seat number and the distance to the object may be stored in a server prepared by the organizer. In the case where the table is stored in the server, the user may access the server and input the seat number, thereby causing the digital monocle 100 to acquire the object distance. As described above, in the case where the relative position to the object can be acquired based on the seat number, the seat number is also included in the information representing the relative position. Further, in a case where the detection unit 215 includes an absolute position sensor such as a global positioning system (GPS), another absolute position sensor may be attached to the object (a player, ball, and referee in case of sporting events, and a performer in case of concerts), and the distance information to the object may be acquired by acquiring the relative position from two absolute positions. Alternatively, the object distance information acquired in previous use may be stored in any of the memories, and the distance information may be acquired by reading the stored object distance information in next use. The distance information acquired in this step is once stored in the memory 209. As described above, in this step, the system control unit 210 functions as a distance information acquisition unit configured to acquire the distance information based on the information from the detection unit 215 and the various kinds of memories (209, 213, and 214).

In step S402, which is an audio arrival time acquisition processing step, the calculation unit 216 calculates a time for audio from the object to arrive at the image capturing and processing apparatus based on the distance information acquired in step S401 and the speed of sound generally defined. In place of calculation of the arrival time based on the speed of sound, a table in which the distance information is associated with the audio arrival time may be stored in the memory, and the calculation unit 216 may acquire the arrival time by referring to the table.

In step S403, which is a display delay time acquisition processing step, the calculation unit 216 functions as a delay time information acquisition unit configured to calculate display delay time information about a timing at which the image data for display is to be output to the display unit 102 based on the time for the audio from the object to arrive at the image capturing and processing apparatus acquired in step S402. Displaying the image of the image data for display in a state of being delayed by the audio arrival time eliminates a lag between the audio input to ears of the user and the image displayed on the display unit 102. However, displaying the image of the image data for display is also delayed in actuality from an original time by a time for generating the image data for display after start of image capturing and a time for loading processing in which the image data for display is read from the memory 209, D/A converted, and loaded as analog data to the display unit 102. Thus, the display delay time information is calculated by subtracting the generation time and the loading processing time of the image data for display from the time for the audio from the object to arrive at the image capturing and processing apparatus acquired in step S402. The generation time and the loading processing time of the image data for display are stored in the memory in manufacturing.

As described above, in step S302, the display delay time information is acquired through the processing in steps S401 to step S403. In place of the processing in step S402 and step S403, a table of the object distance and a corresponding delay time may be stored in the memory, and the display delay time information may be acquired by referring to the display delay time information corresponding to the object distance acquired in step S401.

In step S303, which is an image display processing step, the system control unit 210 displays the image of the image data for display stored in the memory 209 on the display unit 102. The image data for display is converted into data suitable for display on the display unit 102 via the image processing unit 206 and the memory control unit 207. Then, the D/A converter 208 converts the data into analog data receivable by the display unit 102. The display unit 102 finally displays the image of the analog data. At this time, timing to start the display processing on the display unit 102 is delayed by the display delay time acquired in step S302 from the image capturing start time point.

The live-view display on the display unit 102 is performed at a predetermined frame rate by repeating the above-described processing in steps S301 to S303 in a predetermined cycle. At this time, in a case where a change in the distance to the object does not exceed a certain threshold, it is unnecessary to update the delay time acquired in step S302 every time the display image is updated because the audio arrival time is hardly changed. Thus, the object distance acquired in step S401 is compared with the object distance corresponding to the currently-held delay time, and in a case where a difference therebetween is less than or equal to the threshold, it is sufficient to repeat the image display processing in step S303 based on the held delay time. For example, before step S401, a step in which it is determined whether the current time is immediately after start of image capturing and whether the current frame is a first frame (whether delay time has already been acquired), and a step in which it is determined whether the change in the object distance after acquisition of the delay time exceeds the threshold, are provided. In a case where it is determined that the current frame is not the first frame and the change in the object distance after acquisition of the delay time is less than or equal to the threshold, steps S401 to S403 are skipped, and the processing in step S303 is performed by using the delay time used in a previous frame. In contrast, in a case where it is determined that the current frame is the first frame or in a case where it is determined that the change in the object distance exceeds the threshold, the processing in steps S401 to S403 is performed to acquire (update) the delay time.

Alternatively, the user may ultimately adjust the delay time finely and manually by using a delay time adjustment input button (not illustrated, and hereinafter, referred to as adjustment button). For example, the image capturing and processing apparatus includes an adjustment button used in a case where the image is faster than the audio, and an adjustment button used in a case where the image is later than the audio. If the adjustment button used in the case where the image is faster than the audio is pressed, the delay time acquired in step S403 and held is made long. If the adjustment button used in the case where the image is later than the audio is pressed, the held delay time is made short. It is preferable that an upper limit be set to the time adjustable by the adjustment buttons, to prevent a large difference in timing between the image and the audio from being caused by erroneous operation of the adjustment buttons. For example, in the case of an event in which a microphone is used, such as a concert, a situation is expected where a distance to a speaker is shorter than the distance to the object. Thus, a range in which the delay time can be reduced by the user input may be set larger than a range in which the delay time can be increased by the user input.

As described above, the timing at which the image is displayed on the display unit of the image capturing and processing apparatus is delayed to the timing at which the audio from the object arrives at the image capturing and processing apparatus by performing the processing in steps S301 to S303 and the processing in steps S401 to S403. This makes it possible to reduce the difference between the timing at which the audio arrives at the ears of the user and the image display timing.

In the processing illustrated in the first exemplary embodiment, in particular, in the delay time acquisition processing in step S302, if the delay time is acquired in advance, acquisition of the delay time is not necessary in capturing of the image (image data for display) of each frame as illustrated in FIG. 4, in some cases. For example, this corresponds to a case where use of the image capturing and processing apparatus at a designated position is expected, the relative position of the image capturing and processing apparatus to the object is determined in advance, and the delay time based on the relative position is held in advance in any of the various kinds of memories before start of the image capturing processing. Further, in a case where the use position of the image capturing and processing apparatus is not changed from the position in the previous use and where the delay time information acquired the previous time is held and is reusable, the calculation of the delay time is unnecessary. In addition, in the case of the event in which the microphone is used, the sound source is not the object captured in live view but the speaker or the like. In a case where the sound source is not the object, the position of the sound source is fixed, and the distance to the sound source is determined in advance, if the delay time based on the distance to the sound source is acquired in advance before start of the image capturing processing, sub-flow processing to acquire the delay time illustrated in FIG. 4 is not necessary. For example, in the case where the digital monocle 100 is provided to each of the seats in the various kinds of event sites, the organizer of the concert may input in advance, in the memory 209, the delay time based on the distance between the seat and the object or the speaker that is the sound source. Alternatively, the organizer of the concert may prepare a table of the seat number and the delay time, and the user may input the user's own seat number to acquire the delay time. The table may be stored in any of the various kinds of memories of the digital monocle 100 or in the server prepared by the organizer. In the case where the table is stored in the server, the user may access the server and input the seat number, thereby causing the digital monocle 100 to acquire the delay time information and to store the acquired delay time information in the memory before the image capturing processing. As described above, in the case where the relative position to the sound source can be acquired based on the seat number, the seat number is also included in the information representing the relative position. Further, in the case where the detection unit 215 includes an absolute position sensor such as GPS, the distance information to the sound source may be acquired by acquiring the relative position from the position of the fixed sound source and the position acquired from the absolute position sensor. After the distance information to the sound source is acquired, the system control unit 210 controls the calculation unit 216 before image capturing, acquires the delay time based on the speed of sound, the distance, and the generation time and the loading processing time of the image data for display, and stores the delay time in any of the various kinds of memories. The organizer may directly input the delay time in place of the distance to the sound source. Alternatively, the table of the seat number and the delay time may be held in any of the various kinds of memories, and the delay time may be held in the memory 209 when the user inputs the user's own seat number.

In a second exemplary embodiment, processing performed in a case where the acquisition of the display delay time in the image capturing processing as described in the first exemplary embodiment is unnecessary is described with reference to the flowchart of the display delay processing illustrated in FIG. 3. First, as described above, before start of the image capturing processing, the calculation unit 216 acquires the distance to the sound source based on the input information representing the relative position. In the case where the distance to the sound source or the delay time has been directly input, or in the case where the delay time is reused, the step is skipped. Then, the calculation unit 216 appropriately acquires the delay time based on the input information and stores the delay time in the memory 209.

Image capturing processing in step S301 is the same as the image capturing processing described in the first exemplary embodiment.

In delay time acquisition processing in step S302, the delay time information held in advance in any of the memory 209, the nonvolatile memory 213, and the system memory 214 is acquired.

In step S303, display processing is performed to delay the image displayed on the display unit by the display delay time acquired in step S302, in a manner similar to the display processing described in the first exemplary embodiment.

As described above, performing the processing in steps S301 to S303 makes it possible to reduce the lag between the timing at which the audio arrives at the ears of the user and the image display timing without acquiring the delay time in the image capturing.

There is a case where the user experientially feels that it is natural that the audio from a distance is delayed. In this case, inexecution of the delay image display processing illustrated in the first exemplary embodiment can suppress strangeness. Even in this case, however, if the image capturing and processing apparatus has a zoom function, and the image of the object is captured on a closest distance side by using the zoom function, the user feels that the object is present at a position closer than an actual position. Thus, reducing the lag between the audio and the display image by delaying the display image on the closest distance side can make the user feel natural.

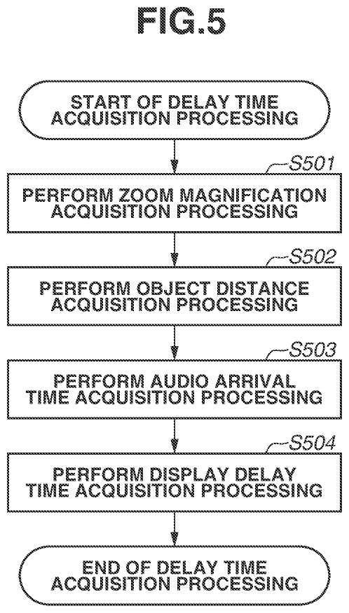

Thus, in a third exemplary embodiment, display processing to adjust the image display timing relative to the audio based on the zoom magnification is performed. Hereinafter, processing according to the present exemplary embodiment is described with reference to the flowchart of the display delay processing illustrated in FIG. 3 and a flowchart of delay time acquisition processing illustrated in FIG. 5.

Step S301 is similar to the image capturing processing step described in the first exemplary embodiment; however, the zoom lens position of the lens group 202 is determined via the system control unit 210 to implement the zoom magnification designated by using the telephoto-side zoom button 104 and the wide-side zoom button 105. In a case where the designated zoom magnification cannot be achieved only by a change in a focal length by the zoom lens, the image processing may be performed through electronic zoom processing by the image processing unit 206 to achieve the zoom magnification. The image capturing processing described in the first exemplary embodiment is performed with the optical configuration and the setting values that achieve the above-described zoom magnification, to generate the image data for display, and the image data for display is stored in the memory 209.

Step S302 is the delay time acquisition processing step; however, a specific acquisition method is different from the acquisition method according to the first exemplary embodiment. Thus, the acquisition method is described with reference to the flowchart of the delay time acquisition processing illustrated in FIG. 5.

In step S501, which is a zoom magnification acquisition processing step, the setting value of the zoom magnification set by using the telephoto-side zoom button 104 and the wide-side zoom button 105 is acquired. The zoom magnification acquired at this time is a zoom magnification taking into consideration both the optical zoom and the electronic zoom. For example, when the focal length of 50 mm and the electronic zoom magnification of 1× are defined as a reference zoom magnification (zoom magnification of 1×), in a case where the focal length is set to 100 mm and the electronic zoom magnification is set to 1×, 2× is acquired as the setting value of the zoom magnification. In a case where the focal length is set to 100 mm and the electronic zoom magnification is set to 2×, 4× is acquired as the setting value of the zoom magnification. The setting value is stored in the memory 209 or the system memory 214, and the value stored in the above-described memory is acquired.

In step S502, which is an object distance acquisition processing step, the distance to the object is acquired in a manner similar to the object distance acquisition processing in step S401 described in the first exemplary embodiment. However, step S502 is different from step S401 according to the first exemplary embodiment in that an apparent object distance taking into consideration the zoom magnification is acquired. More specifically, in the captured image, the distance to the object seems to be reduced by the zoom magnification acquired in the above-described zoom magnification acquisition processing step. Thus, in this step, a distance obtained by reducing the object distance (first object distance) acquired in a manner similar to step S401, by the zoom magnification, is acquired as the object distance (second object distance). For example, in a case where the distance to the object is detected as 300 m, and the zoom magnification acquired in step S501 is 10×, 30 m that is obtained by dividing the distance to the object by the zoom magnification is handled as the second object distance. The second object distance acquired in this step is varied based on the reference zoom magnification, and the object in the size same as the size when the object is actually present at the distance of 30 m is not necessarily displayed on the screen.

In step S503, which is an audio arrival time acquisition processing step, a time for the audio from the object at the distance (30 m in the above example) reduced by the zoom magnification to arrive at the image capturing apparatus is calculated based on the distance information (second object distance) reduced by the zoom magnification, which is acquired in the object distance acquisition processing in step S502, and the speed of sound generally defined.

In step S504, which is a display delay time acquisition processing step, the delay time information is calculated based on the arrival time calculated in step S503 in a manner similar to the display delay time acquisition processing step in step S403 described in the first exemplary embodiment.

As described above, in step S302, the delay time information is acquired through the processing in steps S501 to S504.

In step S303, which is an image display processing step, the image display processing is controlled to delay and display the image based on the display delay time information acquired in step S302 in a manner similar to step S303 described in the first exemplary embodiment.

As described above, the timing at which the image is displayed on the display unit of the image capturing and processing apparatus is adjusted based on the zoom magnification, and the image is displayed by performing the processing in steps S301 to S303 and the processing in steps S501 to S504. In the present exemplary embodiment, in a case where the zoom magnification is set low and the image is captured as if the distance to the object is large, the audio arrival timing and the image display timing are deviated as in a case where a distant object is observed by naked eyes. In contrast, in the case where the image is captured while the zoom magnification is set high to reduce the apparent distance to the object, the difference between the audio arrival timing and the image display timing is reduced as in a case where a close object is observed by naked eyes. As described above, the image display can be performed in a form similar to object observation by naked eyes.

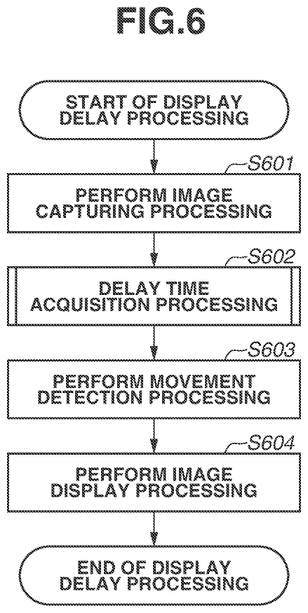

In any of the first to third exemplary embodiments, in a case where the object moves frequently, it is difficult for the user to perform panning by tracking the moving object while viewing the image that is delayed. Thus, in a fourth exemplary embodiment, in a case where it is necessary to track the object, the delay time is adjusted to facilitate the tracking of the object. Processing according to the present exemplary embodiment is described below with reference to a flowchart of display delay processing illustrated in FIG. 6.

In step S601, which is an image capturing processing step, processing similar to the image capturing processing described in the first to third exemplary embodiments is performed.

In step S602, which is a delay time acquisition processing step, processing similar to the delay time acquisition processing described in the first to third exemplary embodiments is performed.

In step S603, which is a movement detection processing step, the calculation unit 216 acquires a movement speed of the image capturing and processing apparatus from a detection result of an acceleration sensor included in the detection unit 215. The movement speed of the image capturing and processing apparatus represents speed of the image capturing and processing apparatus moved by panning. Alternatively, a movement angle of the image capturing and processing apparatus may be acquired from a detection result of an angular velocity sensor in place of the acceleration sensor. Further alternatively, a movement speed (movement speed on an xy plane) of the object may be estimated from a motion vector of the object, which can be obtained by comparing the image captured at the present time point with the image captured immediately before the present time point (image in previous frame), and information representing a movement speed of an optical axis necessary for tracking the object may be acquired. As described above, the calculation unit 216 functions as a movement speed acquisition unit configured to acquire the movement speed of the image capturing and processing apparatus.

In step S604, which is an image display processing step, the image display processing is controlled to delay and display the image based on the display delay time information acquired in step S302, as in step S303 described in the first to third exemplary embodiments. At this time, if the movement speed of the image capturing and processing apparatus acquired by the movement detection processing is greater than or equal to a threshold, the display delay time is reduced to facilitate the tracking of the object. In other words, the delay time is adjusted to be reduced as the movement speed is high, with the display delay time information acquired in step S302 as the maximum value. Alternatively, in a case where the speed greater than or equal to a certain threshold is detected, it may be determined that the image capturing and processing apparatus is tracking the object, and thus the delay time is regarded as zero, and the image of the image data for display generated through the image capturing processing may be displayed as it is on the display unit 102 without delay.

As described above, the display image is displayed while the delay time is adjusted based on the movement of the image capturing and processing apparatus by performing the processing in steps S601 to S604. The above-described processing can make the image capturing and processing apparatus according to any of the first to third exemplary embodiments easily track the object that frequently moves.

In a case where the image capturing and processing apparatus includes an audio recording function using an audio input unit and records audio arriving at the image capturing and processing apparatus, a recorded audio signal and a recorded image signal may be deviated as with the lag between the audio arriving at the ears of the user and the image. Thus, the time lag between the audio signal and the image signal may be reduced by using the techniques according to the first to fourth exemplary embodiments. For example, in a case of using the technique according to the first exemplary embodiment, the image capturing processing and the delay time acquisition processing are performed as in the first exemplary embodiment, and the timing when the image signal is recorded is delayed based on the acquired delay time, in place of delaying the display time. As a result, the audio signal input to the audio input unit at a second time point delayed from a first time point is made correspond to the image data (one frame of image signal) based on the image capturing signal captured by the image capturing device at the first time point, and the image signal and the audio signal are recorded. In the first exemplary embodiment, the delay time is acquired by subtracting the generation time and the development processing time of the image data for display from the audio arrival time. To reduce the lag between the recorded audio and the recorded image, the delay time is acquired by subtracting a time necessary for generating and recording the image data for display, from the audio arrival time.

Alternatively, the lag between the audio signal and the image signal may be reduced not in recording but in reproduction. In this case, the delay time is acquired before the recorded audio signal and the recorded image signal are reproduced, and the image signal is displayed by being delayed by the delay time. This makes it possible to reduce the lag between the reproduced audio and the reproduced image.

Further, in the first to fourth exemplary embodiments, the system control unit 210 and the image processing unit 206 of the digital monocle 100 transmit/receive the information to/from the various kinds of components, thereby controlling the timing when the image is displayed on the display unit 102. Alternatively, a control apparatus configured separately from the digital monocle 100 may control the image display timing by transmitting/receiving various kinds of information to/from the digital monocle 100. For example, the control apparatus may acquire a part or all of pieces of information necessary for the delay time calculation, from the digital monocle 100, acquire the delay time from the information, and control display of the image on the display unit 102 of the digital monocle 100 based on the acquired delay time.

### Other Embodiments

Various embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-118531, filed Jul. 9, 2020, which is hereby incorporated by reference herein in its entirety.

What is claimed is:

1. A display control apparatus, comprising:
at least one processor; and
a memory coupled to the at least one processor, the memory having instructions that, when executed by the at least one processor, cause the display control apparatus to perform operations as:
a delay time information acquisition unit configured to acquire information on a delay time from when a display image to be displayed on a display unit is acquired from an image capturing signal output from an image capturing device to when the display image is displayed on the display unit; and
a display control unit configured to control display of the display image on the display unit at a timing based on the information on the delay time,
wherein the delay time is longer when a distance to a sound source is a second value than when the distance to the sound source is a first value, the second value being greater than the first value.

2. The display control apparatus according to claim 1,
wherein the delay time information acquisition unit includes a distance information acquisition unit configured to acquire distance information on a distance to the sound source, and
wherein the delay time information acquisition unit acquires the information on the delay time based on the distance information acquired by the distance information acquisition unit.

3. The display control apparatus according to claim 1,
wherein the at least one processor further performs operations as an arrival time acquisition unit configured to acquire an arrival time for audio from the sound source to arrive at the display control apparatus, based on distance information, and
wherein the delay time information acquisition unit acquires the information on the delay time based on the arrival time acquired by the arrival time acquisition unit.

4. The display control apparatus according to claim 2, wherein the distance information acquisition unit acquires the distance information on the distance to the sound source based on a relative position with respect to the sound source.

5. The display control apparatus according to claim 1, wherein the delay time information acquisition unit acquires the information on the delay time based on a relative position with respect to the sound source.

6. The display control apparatus according to claim 1,
wherein the at least one processor further performs operations as a zoom magnification setting unit configured to set a zoom magnification of the display image, and
wherein the delay time information acquisition unit acquires the information on the delay time based on information on the set zoom magnification.

7. The display control apparatus according to claim 1,
wherein the at least one processor further performs operations as a movement speed acquisition unit configured to acquire movement speed of an image capturing and processing apparatus, and
wherein the display control unit displays the display image on the display unit based on the movement speed detected by the movement speed acquisition unit and the information on the delay time.

8. The display control apparatus according to claim 1,
wherein the at least one processor further performs operations as a distance change detection unit configured to detect change in the distance to the sound source, and
wherein the display control unit controls the display of the display image on the display unit based on the change in the distance.

9. The display control apparatus according to claim 1, further comprising an adjustment unit configured to adjust the delay time acquired by the delay time information acquisition unit, based on a user operation.

10. An image capturing and processing apparatus, comprising:
the display control apparatus according to claim 1; and
an image processing unit configured to acquire the display image from the image capturing signal.

11. An image capturing and processing apparatus, comprising:
an image processing unit configured to acquire an image signal from an image capturing signal output from an image capturing device;
an audio signal acquisition unit configured to acquire an audio signal corresponding to the image signal via an audio input unit; and
an adjustment unit configured to adjust relative timings of the image signal and the audio signal by associating an audio signal input to the audio input unit at a second time point, with a frame of an image signal based on an image capturing signal captured by the image capturing device at a first time point, the second time point being later than the first time point,
wherein a delay time from the first time point to the second time point is longer when a distance to a sound source is a second value than when the distance to the sound source is a first value, the second value being greater than the first value.

12. An image capturing apparatus, comprising:
an image capturing device; and
the image capturing and processing apparatus according to claim 10.

13. An image capturing apparatus, comprising:
an image capturing device; and
the image capturing and processing apparatus according to claim 11.

14. A method of controlling an image capturing and processing apparatus, the method comprising:
acquiring information on a delay time from when a display image to be displayed on a display unit is acquired from an image capturing signal output from an image capturing device to when the display image is displayed on the display unit; and
controlling display of the display image on the display unit at a timing based on the acquired information on the delay time,
wherein the delay time is longer when a distance to a sound source is a second value than when the distance to the sound source is a first value, the second value being greater than the first value.

15. A method of controlling an image capturing and processing apparatus, the method comprising:
acquiring an image signal from an image capturing signal output from an image capturing device;
acquiring an audio signal corresponding to the image signal via an audio input unit; and
adjusting relative timings of the image signal and the audio signal by associating an audio signal input to the audio input unit at a second time point, with a frame of an image signal based on an image capturing signal captured by the image capturing device at a first time point, the second time point being later than the first time point,
wherein a delay time from the first time point to the second time point is longer when a distance to a sound source is a second value than when the distance to the sound source is a first value, the second value being greater than the first value.
